(19) United States
(12) Patent Application Publication
(10) Pub. No.: US 2026/0246150 A1
(43) Pub. Date: Aug. 20, 2026

(54) MULTIPLE PORT HIGH POWER HORN ANTENNA

(71) Applicant: ThinKom Solutions, Inc., Hawthorne, CA (US)

(72) Inventor: William Henderson, Lomita, CA (US)

(73) Assignee: ThinKom Solutions, Inc., Hawthorne, CA (US)

(21) Appl. No.: 19/529,820

(22) Filed: Feb. 4, 2026

Related U.S. Application Data
(60) Provisional application No. 63/758,564, filed on Feb. 14, 2025.

(51) Int. Cl. H01Q 13/02; H01Q 3/26; H01Q 5/55

(52) U.S. Cl. CPC H01Q 13/02; H01Q 3/2682; H01Q 5/55

(57) ABSTRACT

An antenna includes N antenna input ports, N delay lines, each delay line of the N delay lines having an input for inputting a signal and an output for outputting a signal, each delay line of the N delay lines creates a phase progression among the N output signals when the N inputs signals are in phase and a waveguide mode converter having N input ports and an output port having 2 modes, N being an integer greater than 2. The waveguide mode converter converts a signal received at the input ports into the two modes of the waveguide mode converter output port. Each delay line input is communicatively coupled to a respective antenna input port, and each delay line output is communicatively coupled to a respective waveguide mode converter input port. A horn radiator is communicatively coupled to the waveguide mode converter output port.

### CROSS-REFERENCE RELATED APPLICATIONS

This application claims priority of U.S. Provisional Application No. 63/758,564 filed on Feb. 14, 2025, which is incorporated herein by reference in its entirety.

### TECHNICAL FIELD

The present invention relates generally to radio frequency (RF) electromagnetic signal broadcasting antennas. More particularly, the present invention relates to a multiple port horn antenna capable of radiating high-power.

### BACKGROUND ART

In some microwave systems it is desirable to have very high-power transmission capabilities. The primary figure of merit for such systems is the effective isotropic radiated power (EIRP), but the width of the main beam and the antenna pattern quality are also important. The two most common approaches for this are: (1) an array antenna with a large number of relatively low power sources each connected to an array of non-directional radiators. (2) a single high-power source connected to a single-port directional antenna. Since vacuum-based devices such as magnetrons and klystrons are capable of outputting far greater power than solid state sources, it is necessary to use vacuum-based sources when really extreme power levels are needed. However, method (1) typically employs solid state sources since the required radiator spacing in the antenna array is typically too fine to employ vacuum-based devices. Therefore method (1) is not viable for many extreme power applications. Method (2) has the limitation that only one source is employed. There are some applications in which it is necessary to employ a small number of very high power vacuum-based sources in a single system. In such systems, it is necessary to be able to design for a specific antenna beamwidth and antenna power. The techniques used for large arrays work poorly in this case: if each source is connected to its own non-directive radiator, the overall directivity will typically be too low; if each source is connected to its own directive radiator such as a horn (creating a small array of horns) the overall antenna pattern quality will be poor due to mutual coupling effect between radiators and the inability to obtain an overall aperture distribution that provides low sidelobes.

### SUMMARY OF INVENTION

In light of the above issues, it is desirable to have an antenna with multiple input ports that radiates all of the input energy via a single directive radiator whose characteristics can be tailored to provide a specific beamwidth while providing a good antenna pattern. An antenna in accordance with the invention employs multiple power sources to radiate high-power RF energy. The antenna includes a plurality (N) of input ports, which typically are single mode waveguide ports, although other transmission line media may be used (e.g., coaxial transmission lines). The antenna also includes a plurality (N) of delay lines coupled to respective ones of the input ports, where the delay lines create a phase progression of 0, 1*(360/N), 2*(360/N), . . . (N−1)*(360/). The delay lines feed a waveguide mode converter that converts the multiple phased-shifted signals into the two TE_{1,1} modes of a circular waveguide. The circular waveguide of the waveguide mode converter then feeds the signal to a horn radiator to radiate the RF energy.

The antenna in accordance with the invention, utilizing unique phasing of the delay lines, can direct all of the power into a single symmetric radiating structure. This advantageously overcomes the drawbacks of conventional antenna systems, (e.g., unwanted mutual coupling effects between the antennas, challenges in realizing an appropriate aperture distribution that provides a desired gain and pattern shape, etc.).

According to one aspect of the invention, an antenna includes: N antenna input ports; N delay lines, each delay line of the N delay lines having an input for inputting a signal and an output for outputting a signal, each delay line of the N delay lines configured to create a phase progression among the N output signals when the N inputs signals are in phase; a waveguide mode converter having N input ports and an output port having 2 modes, N being an integer greater than or equal to 3, the waveguide mode converter configured to convert a signal received at the N input ports into the two modes of the waveguide mode converter output port; wherein each input of the N delay lines is communicatively coupled to a respective one of the N antenna input ports, and each output of the N delay lines is communicatively coupled to a respective one of the N waveguide mode converter input ports; and a horn radiator communicatively coupled to the waveguide mode converter output port.

In one embodiment, the output port of the waveguide mode converter comprises a circular waveguide, and signals provided to the N input ports of the waveguide mode converter are converted to signals in the two orthogonal TE₁₁ modes of the circular waveguide.

In one embodiment, the N delay lines are configured to produce a phase progression of 0, 1*(360/N), 2*(360/N) . . . (N−1)*360/N.

In one embodiment, N=3.

In one embodiment, the N antenna input ports comprise signal mode waveguide ports.

In one embodiment, the N antenna input ports comprise coaxial ports.

In one embodiment, the antenna includes N coaxial-to-signal-mode waveguide transitions, each of the N coaxial-to-signal-mode waveguide transitions communicatively coupled to respective ones of the N coaxial ports.

In one embodiment, each N delay line comprises double E-bend.

In one embodiment, the horn radiator comprises one of a conical or pyramidal horn radiator.

According to another aspect of the invention, an antenna includes: a plurality of rectangular waveguides; a circular waveguide; a plurality of delay lines, each delay line having a first port for receiving a signal and a second port for outputting a signal, wherein the first port of each delay line is communicatively coupled to a respective one of the plurality of rectangular waveguides, and the second port of each delay line is communicatively coupled to the circular waveguide; and a horn radiator communicatively coupled to the circular waveguide.

In one embodiment, each rectangular waveguide includes a coaxial port for receiving a signal.

In one embodiment, wherein each rectangular waveguide includes a coax-to-waveguide transition.

In one embodiment, the plurality of delays lines comprise a first delay line, a second delay line, and a third delay line.

In one embodiment, the plurality of delay lines each comprise double E-bends.

In one embodiment, the first delay line is configured to provide 0 degree phasing, the second delay line is configured to provide 120 degree phasing, and the third delay line is configured to provide 240 degree phasing.

In one embodiment, the first delay line is configured to provide a reference phase, the second delay line is configured to provide 120 degree phasing relative to the reference phase, and the third delay line is configured to provide 240 degree phasing relative to the reference phase.

According to another aspect of the invention, an antenna system includes: a reflector antenna; and the antenna as described herein configured as a feed horn for the reflector antenna.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

In the annexed drawings, like references indicate like parts or features.

FIG. 1 is a perspective view of an exemplary antenna in accordance with an embodiment of the invention.

FIG. 2 is a perspective view of a coaxial-to-waveguide transition that may be used in the antenna of FIG. 1.

FIG. 3A is a perspective view of an exemplary waveguide mode converter that may be used in the antenna of FIG. 1.

FIG. 3B is a perspective view of the waveguide mode converter of FIG. 3A illustrating a cone-like structure within the waveguide mode converter, the cone-like structure (109 indicates the location of the top of a truncated cone) operative to direct and combine the signals from the input waveguides towards the circular waveguide.

FIG. 4 is an S-matrix for an exemplary waveguide mode converter that may be used in the antenna of FIG. 1.

FIG. 5 shows that when the S-matrix for the waveguide mode converter shown in FIG. 4 is applied to three input signals with equal amplitude and relative phases of 0, 120°, and 240°, the waveguide mode converter outputs two signals to the circular waveguide modes that are equal amplitude and have relative phases of 0 and 90°.

FIG. 6A is a graph showing the simulated magnitude of the reflection coefficient at the rectangular waveguide ports of the waveguide mode converter of FIGS. 3A and 3B. The results are very close to the nominal value of ⅓ in the S-matrix shown in FIG. 4.

FIG. 6B is a graph showing the simulated magnitude of the coupling between pairs of rectangular waveguide ports in the waveguide mode converter shown in FIGS. 3A and 3B. The results are very close to the nominal value of ⅓ in the S-matrix shown in FIG. 4.

FIG. 7A is a graph showing the simulated magnitudes of the reflection coefficients for the two circular waveguide modes of the waveguide mode converter shown in FIGS. 3A and 3B. The nominal value for this is 0 (the two elements along the diagonal on the lower right of the S-matrix shown in FIG. 4).

FIG. 7B is a graph showing simulated magnitudes of the coupling coefficients between the rectangular ports and the two circular waveguide modes of the circular waveguide port of the waveguide mode converter shown in FIGS. 3A and 3B. All of the results are consistent with the nominal values of the S-matrix shown in FIG. 4.

FIG. 8A is a graph showing the simulated magnitudes of the reflection coefficients on a dB scale at each port for the antenna of FIG. 1. Note that a reflection magnitude of −10 dB implies a return loss of +10 dB.

FIG. 8B is a graph showing the simulated magnitudes of the coupling coefficients on a dB scale between pairs of ports for the antenna of FIG. 1. Note that a coupling magnitude of −10 dB implies an isolation of +10 dB.

FIG. 8C is a graph showing the simulated magnitudes of the effective reflection coefficients at each port when all three ports of the antenna of FIG. 1 are fed a signal with equal amplitude and phase. Note that a reflection magnitude of −20 dB implies a return loss of +20 dB.

FIG. 9 is a graph showing the simulated RHCP and LHCP gain of the antenna of FIG. 1., when the antenna is driven with three equal phase/equal amplitude signals.

### DETAILED DESCRIPTION OF INVENTION

Embodiments of the present invention will now be described with reference to the drawings, wherein like reference numerals are used to refer to like elements throughout. It will be understood that the figures are not necessarily to scale.

The word “about” when immediately preceding a numerical value means a range of plus or minus 10% of that value, e.g., “about 50” means 45 to 55, “about 25,000” means 22,500 to 27,500, etc., unless the context of the disclosure indicates otherwise, or is inconsistent with such an interpretation. For example, in a list of numerical values such as “about 49, about 50, about 55, “about 50” means a range extending to less than half the interval(s) between the preceding and subsequent values, e.g., more than 49.5 to less than 52.5. Furthermore, the phrases “less than about” a value or “greater than about” a value should be understood in view of the definition of the term “about” provided herein.

An antenna in accordance with an embodiment of the present invention includes a plurality (N) of input ports for receiving a signal (N being an integer greater than 1). In one embodiment, the plurality of input ports is configured as single-mode waveguide ports, e.g., a port that allows only the lowest order mode to propagate along the wavelength of interest, while preventing the propagation of higher-order waveguide modes. In one embodiment, the plurality of input ports can be configured using rectangular waveguides as the transmission line media, although other types of transmission line media may be utilized. For example, in another embodiment the plurality of input ports may be configured using a coaxial transmission line as the transmission line media. As discussed in further detail below, when utilizing coaxial transmission lines as the input ports, the antenna can include internal transitions that convert the coaxial transmission lines to single mode waveguides.

The antenna in accordance with the invention further includes plurality (N) of delay lines, where N is greater than or equal to 3. The delay lines, when fed with signals that are in phase, are configured to create the following phase progression among the signals: 0 degrees, 1*(360/N) degrees, 2*(360/N) degrees, . . . (N−1)*(360/) degrees. Each of the N delay lines typically incorporates double bend structure (commonly referred to as a trombone structure). When the delay lines are implemented in waveguide, this will typically be a double E-bend structure, although other types of delay lines are contemplated. If the antenna employs more than one transmission line medium (such as coax and waveguide), the delay lines may be located before or after the transitions between the respective media.

The antenna in accordance with the invention further includes a waveguide mode converter. As used herein, a waveguide mode converter is defined as a device that outputs a waveguide mode (i.e., a transverse field pattern that remains constant as a signal propagates along a straight section of waveguide) different from a waveguide mode that is input to the waveguide mode converter. In the exemplary embodiment the waveguide mode converter includes N inputs and an output having 2 modes (the output of the waveguide mode converter may have more than two modes, but the waveguide mode converter nominally only outputs signals into the two orthogonal TE_{1,1} modes). The N inputs of the waveguide mode converter are coupled to the outputs of the plurality of delay lines. When N signals having TE_{1,0} rectangular modes are input to the waveguide mode converter, it converts the N input signals to the two orthogonal TE_{1,1} modes of a circular waveguide.

A horn radiator is communicatively coupled to the output of the waveguide mode converter, the horn radiator allowing the output of the waveguide mode converter to radiate a directive beam. In one embodiment the horn radiator is a simple conical horn (in which the diameter increases linearly with distance from the input of the horn) radiator, although other types of horn radiators may be utilized. For example, a horn radiator exhibiting a structure in which the diameter increases non-linearly with distance from the input of the horn. Alternatively or additionally, the horn radiator may include a corrugated inner region.

The components of the antenna may be formed from conductive materials, such as metal (e.g., aluminum, copper, copper-plated aluminum), or may be formed from non-conductive material with a metal plating over the non-conductive material. For example, a non-conductive material, such as a plastic or the like, may be plated with copper and/or other metals to provide a conductive surface over the non-conductive material.

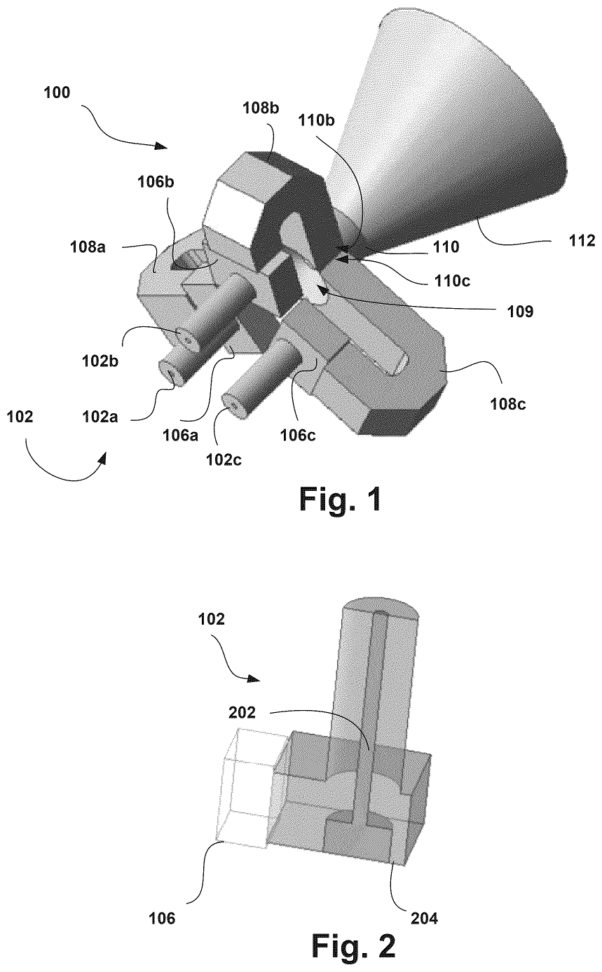

Referring now to FIG. 1, illustrated is an exemplary antenna 100 in accordance with an embodiment of the invention. The antenna 100 includes N antenna input ports 102 for receiving an RF signal. In the illustrated embodiment the antenna input ports are in the form of coaxial-to-waveguide transitions 102a, 102b, 102c operative to receive RF signals from respective coaxial transmission lines (not shown) and transition the transmission line media from coaxial transmission line media to waveguide transmission line media. FIG. 2 illustrates an exemplary coaxial-to-waveguide transition 102, where a center conductor 202 of the coaxial-to-waveguide transition 102 is preferably shorted to the waveguide wall 204 to avoid an unnecessarily high electric field amplitude at the end of the conductor that would limit power handling.

While three antenna input ports 102 are illustrated, it should be appreciated that more input ports may be utilized depending on the application requirements. Further, it will be understood that if transmission line media other than coaxial transmission line media is utilized, coaxial-to-waveguide transitions may be omitted and/or substituted for other transmission media depending on the type of transmission line media. For example, the antenna input ports 102 may take the form of single mode waveguide ports.

Outputs of the coaxial-to-waveguide transitions 102a, 102b, 102c are communicatively coupled to inputs of a respective waveguide 106a, 106b, 106c, such as rectangular waveguides or other conventional waveguides, and outputs of the waveguides 106a, 106b, 106c are communicatively coupled to respective one of N delay lines 108a, 108b, 108c. Hence, each first delay input of the N delay lines is communicatively coupled to a respective one of the N antenna input ports 102a, 102b, 102c.

Each delay line 108a, 108b, 108c of the N delay lines has a first delay input for receiving a signal and a second delay output for outputting a signal, where each delay line 108a, 108b, 108c is configured to create a phase progression from each delay line to the next. For example, the N delay lines can be configured to produce a phase progression of 0, 1*(360/N), 2*(360/N) . . . (N−1)*360/N.

In the illustrated embodiment, the delay lines 108 incorporate double E-bends, each delay line having a first port for receiving a signal and a second port for outputting a signal. As is known, an E-bend is a waveguide bend in which the plane of the electric field is changed. E-bends are formed when a waveguide is bent so the planes of the broad walls change while the planes of the narrow walls remain fixed. This is in contrast to a H-bend which is formed when a waveguide is bent so the planes of the narrow walls change while the planes of the broad walls remain fixed. A double E-bend, as the name implies, is formed by joining the output of one E-bend to the input of another E-bend.

To create the desired delay progression, a length of the transmission line from the delay line input to the double E-bend and the length of transmission from the double E-bend to the delay line output are varied. This is referred to as a trombone configuration. In this manner, and assuming an antenna with three delay lines (N=3, resulting in 3 double E-bends in the context of the present embodiment), a phase progression of 0 degrees, 120 degrees and 240 degrees can be obtained, e.g., the phase at the output of the first delay line is defined as 0 degrees (reference), a second delay line is configured to provide 120 degree phasing (relative to the first delay line), and a third delay line is configured to provide 240 degree phasing (relative to the first delay line).

The output of each of the N delay lines 108a, 108b, 108c is communicatively coupled to a waveguide mode converter 110, the waveguide mode converter 110 having N (e.g., waveguide) input ports (110a, 110b, 110c in the illustrated embodiment) and a circular waveguide 111 communicatively coupled to the N input ports. The circular waveguide 111 provides 2 outputs that are comprised of the two orthogonal TE_{1,1} modes of the circular waveguide (110d, 110e in the illustrated embodiment). The waveguide mode converter 110 receives the signal provided to each input port 102a, 102b, 102c, but phase-shifted by the delay lines 108a, 108b, 108c. The waveguide mode converter 110 is configured to combine and convert the signals received at each input port 110a, 110b, 110c into the two orthogonal TE_{1,1} modes of a circular waveguide (both TE_{1,1} modes are driven with equal amplitude and a 90 degrees phase offset), and to output the converted signal at the output port of the waveguide mode converter 110.

A horn radiator 112 is communicatively coupled to the circular waveguide output of the waveguide mode converter 110, the horn radiator 112 operative to radiate a signal having circular polarization. In one embodiment, the horn radiator 112 is a conical horn radiator. In another embodiment, the horn radiator 112 has a circular input port and a circular output port, with sidewalls connecting the input port to the output port exhibiting a non-linear shape (e.g., an exponential taper). Other shapes may be utilized, such as pyramidal horn radiators having linear or flared transitions from one end of the horn to the other end of the horn. The waves output by the waveguide mode converter 110 enter the horn radiator 112 and travel down the horn and are emitted from the open end of the horn radiator.

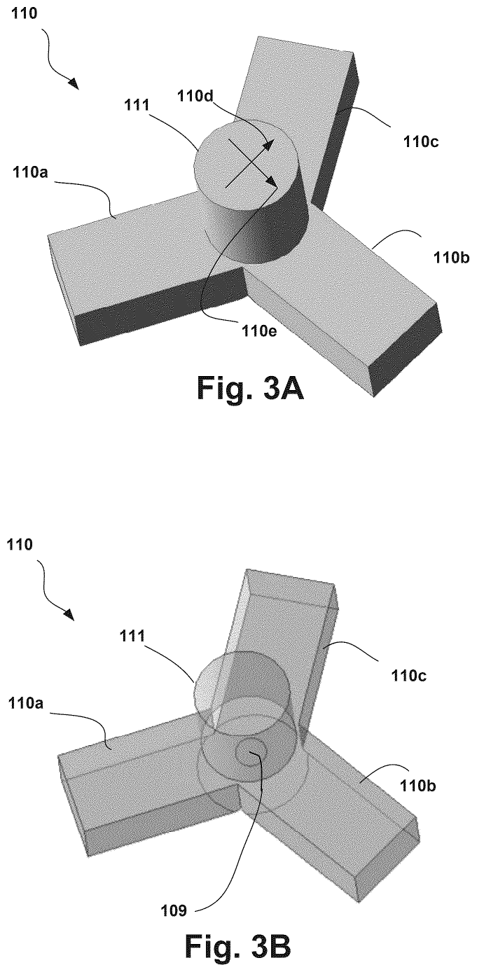

Briefly referring to FIGS. 3A and 3B, illustrated is the waveguide mode converter 110 utilized in the antenna of FIG. 1. The waveguide mode converter 110 is a five-port device, three ports 110a, 110b, 110c for communicatively coupling to delay lines 108a, 108b, 108c and the three (single mode) rectangular waveguides 106a, 106b, 106c, and two ports 110d, 110e for the two TE_{1,1} modes of the circular waveguide. As best seen in FIGS. 1 and 3B, a cone-like structure 109 is disposed inside the waveguide mode converter 110 on a wall opposite the circular waveguide 111. This cone-like structure 109 assists with the impedance matching between the waveguides 106a, 106b, 106c and the circular waveguide 111. It is noted that as the diameter of the waveguide mode converter 110 increases to accommodate more waveguides 106, the circular waveguide 111 connecting the waveguide mode converter 110 to the horn 112 will tend to be smaller than the waveguide mode converter cylinder.

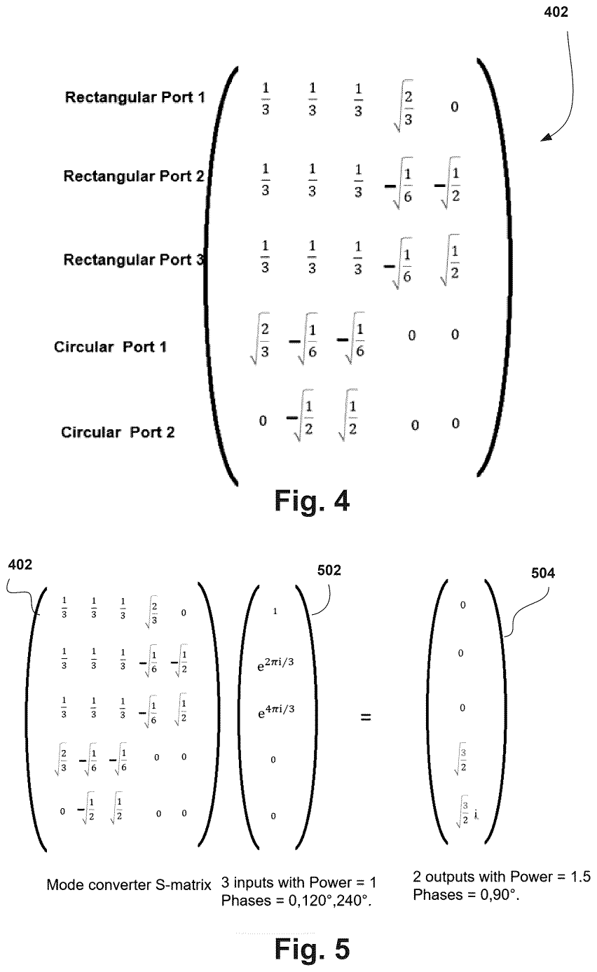

Referring now to FIG. 4, illustrated is the exemplary S-matrix 402 for the three-input, two-output waveguide mode converter 110 utilized in the exemplary antenna of FIG. 1. FIG. 5 shows that when the S-matrix 402 is multiplied by a vector 502 representing three signals input to the three rectangular waveguides 106a, 106b, and 106c that each have an amplitude of 1 and have relative phases of 0 degrees, 120 degrees and 240 degrees, the result is a vector 504 representing two equal amplitude signals coming out of the two TE_{1,1} modes 110d and 110e of the circular waveguide. The signals in the two modes have a relative phase of 90°. Nothing comes out of the rectangular waveguide ports 106a, 106b, 106c (i.e., there is no reflection from the waveguide mode converter back to the input ports, as is shown by the three elements in the vector 504 that are equal to zero). This demonstrates that a device (i.e. the waveguide mode converter) with this S-matrix 402 will provide the desired outputs when given the correct inputs.

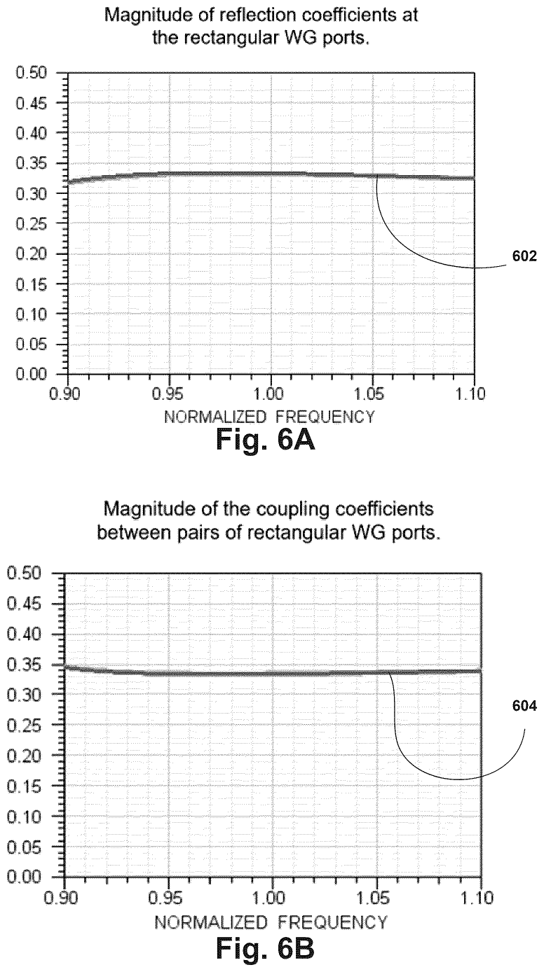

Referring now to FIGS. 6A and 6B, illustrated are simulation results showing the S-parameters for rectangular waveguide reflection magnitude 602 (FIG. 6A) and the coupling magnitude between pairs of rectangular waveguide ports 604 (FIG. 6B) vs. frequency for each rectangular waveguide input 110a, 110b, 110c of the waveguide mode converter 110. While it appears only a single trace is present in each of FIGS. 6A and 6B, there are three essentially identical traces in FIG. 6A and six essentially identical traces in FIG. 6B. As can be seen, both the reflection magnitude 602 for each of the three rectangular waveguides inputs 110a, 110b, 110c and the rectangular coupling magnitude 604 are about ⅓. The S-matrix elements that correspond to the results in these two figures are the nine elements in the upper left corner of the matrix shown in FIG. 4 (all of which have a value of ⅓).

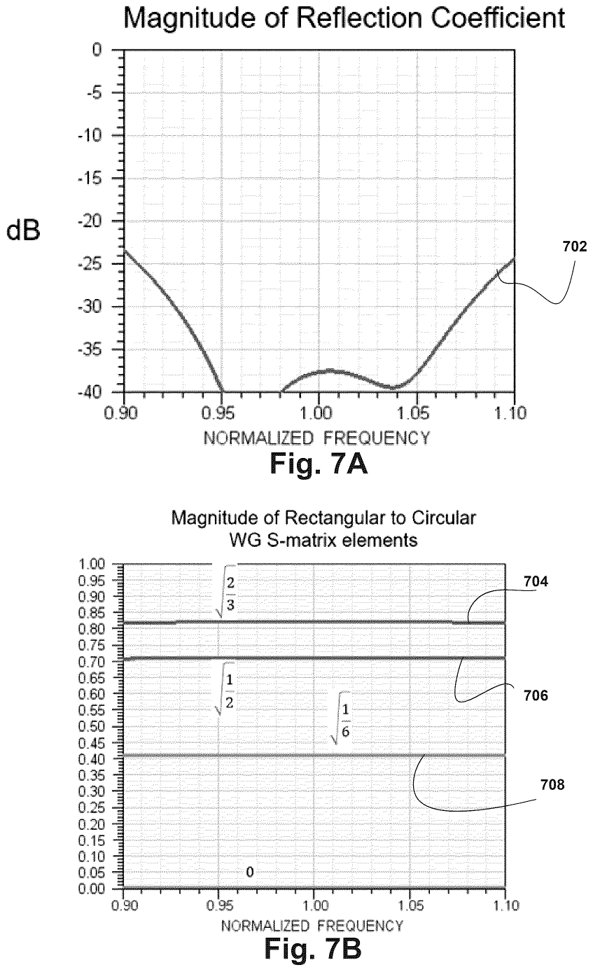

FIGS. 7A and 7B are simulation results showing the reflection coefficient of the two TE_{1,1} circular waveguide modes and the coupling coefficients between the rectangular and circular waveguides vs frequency for the waveguide mode converter 110. In FIG. 7A, the reflection coefficients are very low, especially near the center of the frequency range. This is consistent with the fact the values for the S-matrix elements in FIG. 4 that correspond to these results are equal to zero. The results shown in FIG. 7B are also consistent with FIG. 4 (with values very nearly equal to 0, SQRT(⅙), SQRT(½), and SQRT(⅔).

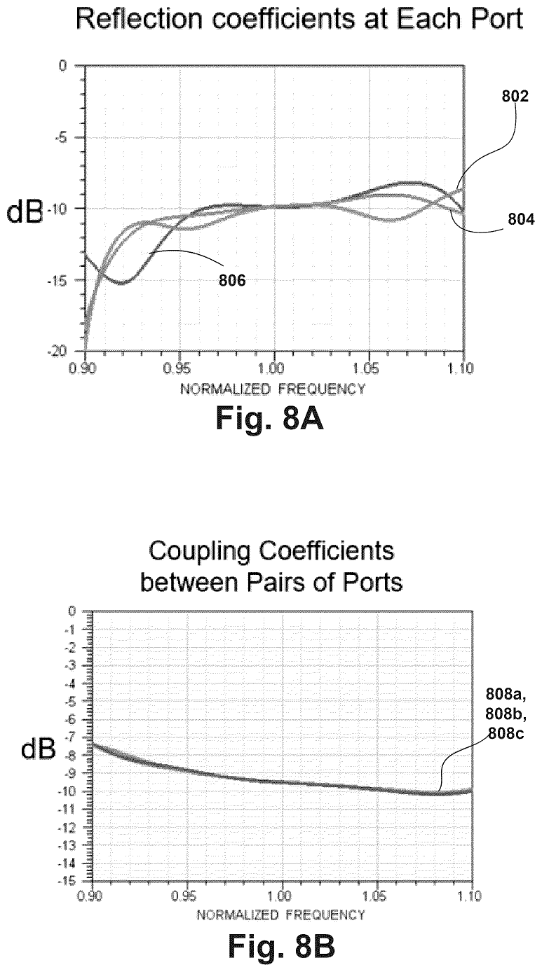

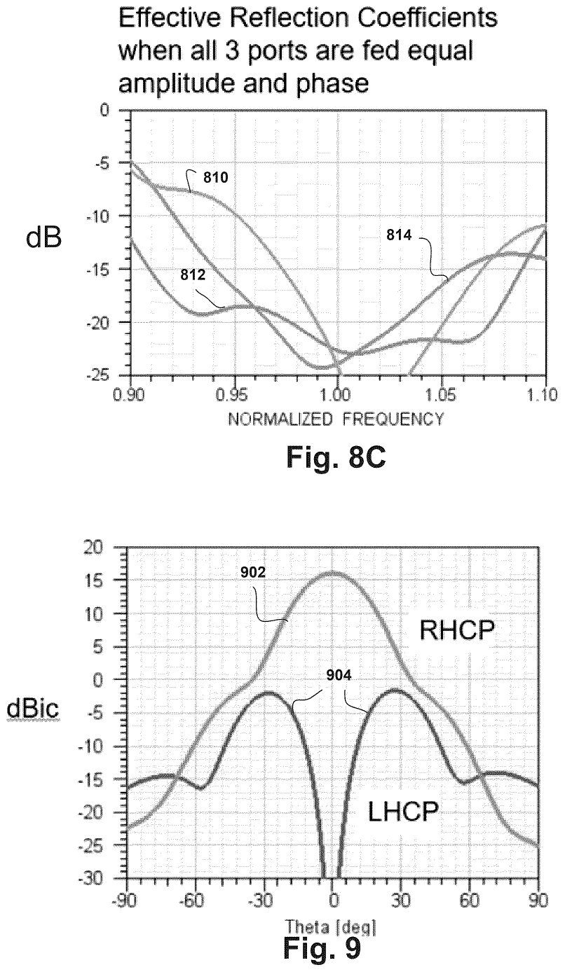

Moving now to FIGS. 8A-8C, illustrated are full antenna simulation graphs for the reflection coefficient at each port (FIG. 8A), the coupling coefficients between pairs of ports (FIG. 8B) and the effective reflection coefficients when all three ports are fed equal amplitudes and phase (FIG. 8C). All results here are expressed in dB. Note that a reflection coefficient of −10 dB, implies a return loss of +10 dB, and a coupling coefficient of −10 dB implies +10 dB isolation. As can be seen in FIGS. 8A and 8B, near the center of the frequency range, both the return loss and the isolation are about +10 dB. When the input ports are fed with equal amplitude and equal phase signals, the reflected and coupled signals cancel each other to a large degree leading to fairly low power levels going back to the input ports. This is shown in FIG. 8C, which shows that near the center of the band the signals going back to the input ports are typically 15-20 dB below the input signal level. This implies that the effective return loss is about 15-20 dB. Note that the fact that there is significant difference in the reflection magnitudes at the individual ports is due to the fact that the distances between the coax to waveguide transitions and the E-bends and between the E-bends and the waveguide mode converter are different for each port.

FIG. 9 illustrates full antenna simulated patterns for the antenna 100 of FIG. 1. As can be seen, at bore site the gain for right-hand circular polarization 902 is over 15 dB, while the gain for left-hand circular polarization 904 is very low. This indicates the exemplary antenna 100 is optimal for right-hand circular polarization, with very high cross-pol isolation.

In addition to being used as a transmit antenna, the antenna in accordance with the invention may also be used as a feed for another antenna. For example, an antenna system may include a reflector antenna, where the antenna in accordance with the invention is configured as a feed horn for the reflector antenna.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

What is claimed is:

1. An antenna, comprising:
N antenna input ports;
N delay lines, each delay line of the N delay lines having an input for inputting a signal and an output for outputting a signal, each delay line of the N delay lines configured to create a phase progression among the N output signals when the N inputs signals are in phase;
a waveguide mode converter having N input ports and an output port having 2 modes, N being an integer greater than or equal to 3, the waveguide mode converter configured to convert a signal received at the N input ports into the two modes of the waveguide mode converter output port;
wherein each input of the N delay lines is communicatively coupled to a respective one of the N antenna input ports, and each output of the N delay lines is communicatively coupled to a respective one of the N waveguide mode converter input ports; and
a horn radiator communicatively coupled to the waveguide mode converter output port.

2. The antenna according to claim 1, wherein the output port of the waveguide mode converter comprises a circular waveguide, and signals provided to the N input ports of the waveguide mode converter are converted to signals in the two orthogonal TE₁₁ modes of the circular waveguide.

3. The antenna according to claim 1, wherein the N delay lines are configured to produce a phase progression of 0, 1*(360/N), 2*(360/N) . . . (N−1)*360/N.

4. The antenna according to claim 1, wherein N=3.

5. The antenna according to claim 1, wherein the N antenna input ports comprise signal mode waveguide ports.

6. The antenna according to claim 1, wherein the N antenna input ports comprise coaxial ports.

7. The antenna according to claim 6, further comprising N coaxial-to-signal-mode waveguide transitions, each of the N coaxial-to-signal-mode waveguide transitions communicatively coupled to respective ones of the N coaxial ports.

8. The antenna according to claim 1, wherein each N delay line comprises double E-bend.

9. The antenna according to any one of claim 1, wherein the horn radiator comprises one of a conical or pyramidal horn radiator.

10. An antenna, comprising:
a plurality of rectangular waveguides;
a circular waveguide;
a plurality of delay lines, each delay line having a first port for receiving a signal and a second port for outputting a signal, wherein the first port of each delay line is communicatively coupled to a respective one of the plurality of rectangular waveguides, and the second port of each delay line is communicatively coupled to the circular waveguide; and
a horn radiator communicatively coupled to the circular waveguide.

11. The antenna according to claim 10, wherein each rectangular waveguide includes a coaxial port for receiving a signal.

12. The antenna according to claim 10, wherein each rectangular waveguide includes a coax-to-waveguide transition.

13. The antenna according to claim 10, wherein the plurality of delays lines comprise a first delay line, a second delay line, and a third delay line.

14. The antenna according to claim 10, wherein the plurality of delay lines each comprise double E-bends.

15. The antenna according to claim 10, wherein the first delay line is configured to provide 0 degree phasing, the second delay line is configured to provide 120 degree phasing, and the third delay line is configured to provide 240 degree phasing.

16. The antenna according to claim 10, wherein the first delay line is configured to provide a reference phase, the second delay line is configured to provide 120 degree phasing relative to the reference phase, and the third delay line is configured to provide 240 degree phasing relative to the reference phase.

17. An antenna system, comprising:
a reflector antenna; and
the antenna according to claim 1 configured as a feed horn for the reflector antenna.
